(19) United States
(12) Patent Application Publication
(10) Pub. No.: US 2024/0381287 A1
(43) Pub. Date: Nov. 14, 2024

(54) TELECOMMUNICATION SYSTEM

(71) Applicant: Samsung Electronics Co., Ltd., Suwon-si (KR)

(72) Inventors: Mahmoud WATFA, Staines (GB); Lalith KUMAR, Bengaluru (IN)

(21) Appl. No.: 18/659,289

(22) Filed: May 9, 2024

(30) Foreign Application Priority Data
May 11, 2023 (IN) 202331033325
Apr. 11, 2024 (GB) 2405190.6

(51) Int. Cl. H04W 60/06; H04W 12/106; H04W 76/20

(52) U.S. Cl. CPC H04W 60/06; H04W 12/106; H04W 76/20

(57) ABSTRACT

The disclosure relates to a fifth generation (5G) or sixth generation (6G) communication system for supporting a higher data transmission rate. A method performed by a User Equipment (UE) is provided. The method includes determining to include unavailability information in a deregistration request message, and transmitting, to a network entity, the deregistration request message, wherein the unavailability information is included in the deregistration request message as non-cleartext information, wherein the deregistration request message includes a non-access stratum (NAS) message container information element (IE), wherein the unavailability information is included in the NAS message container IE, and wherein at least a part of the NAS message container IE is ciphered by the UE.

### CROSS-REFERENCE TO RELATED APPLICATION(S)

This application is based on and claims priority under 35 U.S.C. § 119(a) of an Indian patent application number 202331033325, filed on May 11, 2023, in the Indian Patent Office, and of a United Kingdom patent application number 2405190.6, filed on Apr. 11, 2024, in the United Kingdom Intellectual Property Office, the disclosure of each of which is incorporated by reference herein in its entirety.

### BACKGROUND

### 1. Field

The disclosure relates to Protocol Data Unit (PDU) Session management. More particularly, the disclosure relates to the unavailability of a PDU session and its control. It further relates to the Uplink Data Status Information Element (IE) in certain circumstances.

### 2. Description of Related Art

Fifth generation (5G) mobile communication technologies define broad frequency bands such that high transmission rates and new services are possible, and can be implemented not only in “Sub 6 GHz” bands such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The Fifth Generation System (5GS) defined initial Non-Access Stratum (NAS) message protection which enables a User Equipment (UE) that has a valid security context to protect information that is sent to the network from idle mode. The protection—which involves integrity protection and ciphering—of information is required in order to achieve user privacy such that a rogue entity should not be able to track a user or understand what information is being communicated with the network. It should be noted that there are some information elements of NAS messages that are sent with no protection since the network would need to understand certain aspects in order to properly process the NAS message contents. For example, the message identifier which, as an example, differentiates a Registration Request message from a Service Request message and the UE's identity, or other information elements (IEs) are sent without protection and are hence referred to as cleartext IEs. Other IEs which are only sent protected are referred to as non-cleartext IEs. The cleartext IEs are explicitly listed in section 4.4.6 of third generation partnership project (3GPP) TS 24.501 which also describes the initial NAS message protection framework. This description is quoted below from 3GPP TS 24.501:

### “4.4.6 Protection of Initial NAS Signalling Messages

The 5GS supports protection of initial NAS messages as specified in 3GPP TS 33.501 [24]. The protection of initial NAS messages applies to the REGISTRATION REQUEST, SERVICE REQUEST and CONTROL PLANE SERVICE REQUEST message, and is achieved as follows:
a) If the UE does not have a valid 5G NAS security context, the UE sends a REGISTRATION REQUEST message including cleartext IEs only. After activating a 5G NAS security context resulting from a security mode control procedure:
1) if the UE needs to send non-cleartext IEs, the UE shall include the entire REGISTRATION REQUEST message (i.e. containing both cleartext IEs and non-cleartext IEs) in the NAS message container IE and shall include the NAS message container IE in the SECURITY MODE COMPLETE message; or
2) if the UE does not need to send non-cleartext IEs, the UE shall include the entire REGISTRATION REQUEST message (i.e. containing cleartext IEs only) in the NAS message container IE and shall include the NAS message container IE in the SECURITY MODE COMPLETE message.
b) If the UE has a valid 5G NAS security context and:
1) the UE needs to send non-cleartext IEs in a REGISTRATION REQUEST or SERVICE REQUEST message, the UE includes the entire REGISTRATION REQUEST or SERVICE REQUEST message (i.e. containing both cleartext IEs and non-cleartext IEs) in the NAS message container IE and shall cipher the value part of the NAS message container IE. The UE shall then send a REGISTRATION REQUEST or SERVICE REQUEST message containing the cleartext IEs and the NAS message container IE;
2) the UE needs to send non-cleartext IEs in a CONTROL PLANE SERVICE REQUEST message:
i) if cellular internet of things (CIoT) small data container IE is the only non-cleartext IE to be sent, the UE shall cipher the value part of the CIoT small data container IE. The UE shall then send a CONTROL PLANE SERVICE REQUEST message containing the cleartext IEs and the CIoT small data container IE;
ii) otherwise, the UE includes non-cleartext IEs in the NAS message container IE and shall cipher the value part of the NAS message container IE. The UE shall then send a CONTROL PLANE SERVICE REQUEST message containing the cleartext IEs and the NAS message container IE;
3) the UE does not need to send non-cleartext IEs in a REGISTRATION REQUEST or SERVICE REQUEST message, the UE sends the REGISTRATION REQUEST or SERVICE REQUEST message without including the NAS message container IE; or
4) the UE does not need to send non-cleartext IEs in a CONTROL PLANE SERVICE REQUEST message, the UE sends the CONTROL PLANE SERVICE REQUEST message without including the NAS message container IE and the CIoT small data container IE.

When the initial NAS message is a REGISTRATION REQUEST message, the cleartext IEs are:
Extended protocol discriminator;
Security header type;
Spare half octet;
Registration request message identity;
5GS registration type;
Key set identifier for 5G (ngKSI);
5GS mobile identity;
UE security capability;
Additional global unique temporary identifier (GUTI);
UE status;
Evolved packet system (EPS) NAS message container;
Network identifier (NID); and
Public land mobile network (PLMN) with disaster condition.

When the initial NAS message is a SERVICE REQUEST message, the cleartext IEs are:
Extended protocol discriminator;
Security header type;
Spare half octet;
ngKSI;
Service request message identity;
Service type; and
5G-S-temporary mobile subscriber identity (TMSI).

When the initial NAS message is a CONTROL PLANE SERVICE REQUEST message, the cleartext IEs are:
Extended protocol discriminator;
Security header type;
Spare half octet;
ngKSI;
Control plane service request message identity; and
Control plane service type.

When the UE sends a REGISTRATION REQUEST or SERVICE REQUEST or CONTROL PLANE SERVICE REQUEST message that includes a NAS message container IE, the UE shall set the security header type of the initial NAS message to “integrity protected”.

When the Access and Mobility Management Function (AMF) receives an integrity protected initial NAS message which includes a NAS message container IE, the AMF shall decipher the value part of the NAS message container IE. If the received initial NAS message is a REGISTRATION REQUEST message or a SERVICE REQUEST message, the AMF shall consider the NAS message that is obtained from the NAS message container IE as the initial NAS message that triggered the procedure.

When the AMF receives a CONTROL PLANE SERVICE REQUEST message which includes a CIoT small data container IE, the AMF shall decipher the value part of the CIoT small data container IE and handle the message as specified in subclause 5.6.1.4.2.

When the initial NAS message is a DEREGISTRATION REQUEST message, the UE always sends the NAS message unciphered.

If the UE:
a) has 5G-EA0 as a selected 5G NAS security algorithm; and
b) selects a PLMN other than Registered PLMN and equivalent PLMN (EPLMN) over one access;
the UE shall send an initial NAS message including cleartext IEs only via the access type associated with the newly selected PLMN as described in this subclause for the case when the UE does not have a valid 5G NAS security context.

If the UE:
a) has 5G-EA0 as a selected 5G NAS security algorithm; and
b) selects a PLMN other than Registered PLMN and EPLMN over one access, and the Registered PLMN or EPLMN is not registering or registered over other access;
the UE shall delete the 5G NAS security context.

NOTE: UE deletes the 5G NAS security context only if the UE is not in the connected mode.”

The above states that in the case of the initial message being a Deregistration Request message, the UE always sends the message unciphered. This means that any information which is included in the Deregistration Request message will be sent with no protection.

The 5GS supports the UE indicating that it may be unavailable due to some event whereby the UE will then store its context in the Universal Subscriber Identity Module (USIM) and re-use it after it becomes available again. The following is from section 5.3.26 of 3GPP TS 24.501 about this feature:

“If the UE and network support unavailability period and an event is triggered in the UE making the UE unavailable for a certain period of time, the UE may store its 5G mobility management (5GMM) and 5G session management (5GSM) context in USIM or non-volatile memory to be able to reuse it after the unavailability period.

NOTE: How the UE stores its contexts is UE implementation specific.

To activate the unavailability period, the UE provides an unavailability period duration during the registration procedure or during the de-registration procedure (see 3GPP TS 23.501 [8] and 3GPP TS 23.502 [9]). The support for the unavailability period is negotiated in the registration procedure. If the UE provided an unavailability period duration in the last registration procedure or de-registration procedure, the AMF considers the UE unreachable until the UE re-register for a normal service without providing an unavailability period duration. During the registration procedure, the AMF may determine the value of the periodic registration update timer (T3512) provided to the UE based on the unavailability period duration. The AMF releases the N1 signalling connection after the completion of the registration procedure in which the UE provided an unavailability period duration.

When the unavailability period is activated, all NAS timers are stopped and associated procedures aborted except for timers T3512, T3346, T3447, T3396, T3584, T3585, any back-off timers, T3247, and the timer T controlling the periodic search for home PLMN (HPLMN) or equivalent HPLMN (EHPLMN) or higher prioritized PLMNs (see 3GPP TS 23.122 [5]).”

As can be seen from above, the UE can also include the unavailability period as part of the deregistration procedure. It can also be seen from the contents of the Deregistration Request message, shown below from 3GPP TS 24.501, that the UE can include the unavailability period:

TABLE 8
2.12.1.1: DEREGISTRATION REQUEST message content

| | Information | | | | |
|---|---|---|---|---|---|
| IEI | Element | Type/Reference | Presence | Format | Length |
| | Extended | Extended protocol | M | V | 1 |
| | protocol | discriminator | | | |
| | discriminator | 9.2 | | | |
| | Security header | Security header | M | V | 1/2 |
| | type | type 9.3 | | | |
| | Spare half octet | Spare half octet | M | V | 1/2 |
| | | 9.5 | | | |
| | De-registration | Message type | M | V | 1 |
| | request message | 9.7 | | | |
| | Identity | | | | |
| | De-registration | De-registration | M | V | 1/2 |
| | type | type 9.11.3.20 | | | |
| | ngKSI | NAS key set | M | V | 1/2 |
| | | identifier 9.11.3.32 | | | |
| | 5GS mobile | 5GS mobile | M | LV-E | 6-n |
| | identity | identity 9.11.3.4 | | | |
| 3C | Unavailability | GPRS timer 3 | O | TLV | 3 |
| | period duration | 9.11.2.5 | | | |

From the above table, it can be seen that the Unavailability period duration IE can be included by the UE in the Deregistration Request message.

The above information is presented as background information only to assist with an understanding of the disclosure. No determination has been made, and no assertion is made, as to whether any of the above might be applicable as prior art with regard to the disclosure.

### SUMMARY

One problem in the prior art relates to a lack of clarity on how to send the unavailability period i.e. whether it should be security protected or not. As indicated earlier, the cleartext IEs for every message are explicitly listed, however for the Deregistration Request message, it is not explicitly indicated if the message will contain any cleartext IE. In fact, the standard specification does not even consider the Deregistration Request message for the purpose of specifying which IE can be sent in the clear. As such this can lead to different UE behaviors and subsequently a non-standard behavior that can potentially lead to unpredictable network reactions. Note that the IE can also be sent by the UE in the Registration Request message for which the IE is not indicated to be a cleartext IE. Therefore, this creates contradiction with respect to how the IE should be treated across different NAS messages.

If it is assumed that the Unavailability duration period IE should be sent protected, then this can only be done by using the NAS message container IE which would then contain this information. However, according to the definition of the Deregistration Request message, the NAS message container IE is not present and hence it is not feasible to send the unavailability protection in a secured manner when the UE is in idle mode.

Aspects of the disclosure are to address at least the above-mentioned problems and/or disadvantages and to provide at least the advantages described below. Accordingly, an aspect of the disclosure is to provide a method and apparatus for sending unavailability period information in a security protected method.

Additional aspects will be set forth in part in the description which follows and, in part, will be apparent from the description, or may be learned by practice of the presented embodiments.

In accordance with an aspect of the disclosure, a method performed by a user equipment (UE) is provided. The method includes determining to include unavailability information in a deregistration request message, and transmitting, to a network entity, the deregistration request message, wherein the unavailability information is included in the deregistration request message as non-cleartext information, wherein the deregistration request message includes a non-access stratum (NAS) message container information element (IE), wherein the unavailability information is included in the NAS message container IE, and wherein at least a part of the NAS message container IE is ciphered by the UE.

In accordance with another aspect of the disclosure, a UE in a wireless communication system is provided. The UE includes a transceiver, memory storing one or more computer programs, and one or more processors communicatively coupled to the transceiver and the memory, wherein the one or more computer programs include computer-executable instructions that, when executed by the one or more processors, cause the UE to determine to include unavailability information in a deregistration request message, transmit, to a network entity, the deregistration request message, wherein the unavailability information is included in the deregistration request message as non-cleartext information, wherein the deregistration request message includes a non-access stratum (NAS) message container information element (IE).

In accordance with another aspect of the disclosure, one or more non-transitory computer-readable storage media storing one or more computer programs including computer-executable instructions that, when executed by one or more processors of a user equipment (UE), cause the UE to perform operations are provided. The operations include determining to include unavailability information in a deregistration request message, and transmitting, to a network entity, the deregistration request message, wherein the unavailability information is included in the deregistration request message as non-cleartext information, wherein the deregistration request message includes a non-access stratum (NAS) message container information element (IE), wherein the unavailability information is included in the NAS message container IE, and wherein at least a part of the NAS message container IE is ciphered by the UE.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 shows a representation of a UE in communication with a network, according to an embodiment of the disclosure; and

FIG. 2 shows a flowchart illustrating a method according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the disclosure belongs. Such terms as those defined in a generally used dictionary are to be interpreted to have the meanings equal to the contextual meanings in the relevant field of art, and are not to be interpreted to have ideal or excessively formal meanings unless clearly defined in the disclosure.

Embodiments of the disclosure described herein can be generally classified into two variants. In the first, the Unavailability period duration IE should be explicitly indicated to be an IE which is sent in the clear i.e. the IE should be considered as a cleartext IE and as such all UE implementations and network implementation would expect a same handling of the IE.

The second variant is to ensure that the IE is sent in a protected manner i.e. the IE should be a non-cleartext IE. In this case, the necessary changes are required in the UE and network side to achieve this objective.

It should be noted that the term unavailability information may be used to refer to the Unavailability period duration IE for brevity.

Moreover, embodiments herein may be applicable to all other similar indications which the UE may send that is related to UE unavailability. For example, the UE may send a general indication to inform the network that it (i.e. the UE) will be unavailable but without necessarily providing the actual unavailability period. As such all the embodiments herein may also apply to that generic indication. The embodiments herein can also apply for the case when the UE is indicating that it is entering discontinuous coverage. In this case, the initial NAS message may be a Registration Request message and all the details herein can therefore apply accordingly.

As such any embodiment which is related to the Unavailability period duration IE can also be applied to any other indication (e.g. indication about loss of coverage or indication about entering discontinuous coverage) which may be sent using any IE and/or bit position. The embodiments would therefore also apply to any other IE that can carry any such indication(s).

In a first embodiment, the UE sends the unavailability information as a cleartext information. In this case, the unavailability information (e.g. the Unavailability period duration IE) should be sent by the UE as a cleartext IE, optionally when the UE is sending the NAS message from idle mode (e.g. from 5GMM-IDLE mode).

As such, when the UE wants to send the unavailability information (e.g. the Unavailability period duration IE) in the Registration Request message or the Deregistration Request message, then the UE should send the information as a cleartext IE i.e. the information should not be ciphered.

As such, in this case, the unavailability information (e.g. the Unavailability period duration IE) is not included as part of the NAS message container IE which is in turn included in the Registration Request message, or which may be included in the Deregistration Request message if so needed in the future.

Based on this, the standard specification should be updated to explicitly indicate that the unavailability information (e.g. the Unavailability period duration IE) should be sent as a cleartext IE when this information is included in any NAS message such as the Registration Request message or the Deregistration Request message (or the Service Request message or the Control Plane Service Request message, or optionally any initial NAS message).

In a second embodiment, the UE sends the unavailability information as a non-cleartext information. In this embodiment, the unavailability information (e.g. the Unavailability period duration IE) should be sent as non-cleartext IE when this information is included in any initial NAS message e.g. the Registration Request message or the Deregistration Request message (or other initial NAS messages), where optionally the message is sent from idle mode (e.g. from 5GMM-IDLE mode).

As such, when the UE needs to send the unavailability information (e.g. the Unavailability period duration IE) in the Registration Request message where this NAS message is to be sent from idle mode (e.g. from 5GMM-IDLE mode), then the UE should ensure that the unavailability information (e.g. the Unavailability period duration IE) is sent as a non-cleartext IE and hence the unavailability information (e.g. the Unavailability period duration IE) should be included in the NAS message container IE.

Note that the network (e.g. Access and Mobility Management Function (AMF)) is already able to process the Registration Request message which contains non-cleartext IEs, however the network (e.g. AMF) does not currently process any non-cleartext IE in the Deregistration Request message. Therefore, a solution is needed to ensure that the network (e.g. the AMF) can actually process non-cleartext IE in the Deregistration Request message where this message is optionally sent by the UE (and hence optionally received by the network from the UE). There are two possible options described next.

In a first option, the UE always sends the Unavailability period duration IE in a secured manner.

In this first option, if the UE supports the unavailability period (e.g. the UE sets/had set the UN-PER bit to “unavailability period supported” in the 5GMM capability IE of the REGISTRATION REQUEST message) and the network had indicated the support of (and optionally had indicated the acceptance to use) unavailability period for the UE (e.g. the AMF had set the UN-PER bit to “unavailability period supported” in the 5GS network feature support IE in the REGISTRATION ACCEPT message), then the UE will behave as follows when sending the Unavailability period duration IE in the Deregistration Request message:

The UE shall include the Unavailability period duration IE in the NAS message container IE. The UE should then cipher the value part of the NAS message container.

The UE then includes the NAS message container IE as part of the Deregistration Request message and hence the UE sends the Deregistration Request message:

As such, the Deregistration Request message includes the NAS message container IE which in turn includes the Unavailability period duration IE.

Furthermore, the value part of the NAS message container IE is sent ciphered.

According to the above, it is then required to explicitly list the IEs of the Deregistration Request message which are therefore to be considered as cleartext IEs by the UE or the network.

Therefore, for the Deregistration Request message, the following should be considered as cleartext IEs:
Extended protocol discriminator
Security header type
Spare half octet
De-registration request message identity
De-registration type
ngKSI
5GS mobile identity

Based on the above, the Deregistration Request message should be updated to now include the NAS message container IE and hence the NAS message should be as follows, where the NAS message container IE which is proposed to be included (per the details herein) is now shown to be part of the Deregistration Request message:

| | Information | Type/ | | | |
|---|---|---|---|---|---|
| IEI | Element | Reference | Presence | Format | Length |
| | Extended | Extended protocol | M | V | 1 |
| | protocol | discriminator | | | |
| | discriminator | 9.2 | | | |
| | Security | Security header | M | V | 1/2 |
| | header type | type | | | |
| | | 9.3 | | | |
| | Spare half octet | Spare half octet | M | V | 1/2 |
| | | 9.5 | | | |
| | De-registration | Message type | M | V | 1 |
| | request message | 9.7 | | | |
| | identity | | | | |
| | De-registration | De-registration | M | V | 1/2 |
| | type | type | | | |
| | | 9.11.3.20 | | | |
| | ngKSI | NAS key set | M | V | 1/2 |
| | | identifier | | | |
| | | 9.11.3.32 | | | |
| | 5GS mobile | 5GS mobile | M | LV-E | 6-n |
| | identity | identity | | | |
| | | 9.11.3.4 | | | |
| 3C | Unavailability | GPRS timer 3 | O | TLV | 3 |
| | period duration | 9.11.2.5 | | | |
| 71 | NAS message | NAS message | O | TLV-E | 4-n |
| | container | container | | | |
| | | 9.11.3.33 | | | |

The additions in the Deregistration Request message (as shown above) are sown underlined.

When the UE sends a Deregistration Request message that includes a NAS message container IE, the UE shall set the security header type of the initial NAS message to “integrity protected”.

For this option, the network behavior must also be adapted as follows.

When the AMF receives an integrity protected initial NAS message which includes a NAS message container IE, the AMF shall decipher the value part of the NAS message container IE. If the received initial NAS message is a Deregistration Request message which contains a NAS message container IE, the AMF shall decipher the value part of the NAS message container IE and process its contents (which may include the Unavailability period duration IE).

Optionally the AMF behaves as set out above if any of the following conditions are met:

the UE supports the unavailability period i.e. the UE had set the UN-PER bit to “unavailability period supported” in the 5GMM capability IE of the REGISTRATION REQUEST message

the AMF supports and accepts the use of unavailability period for the UE, i.e. the AMF had set the UN-PER bit to “unavailability period supported” in the 5GS network feature support IE in the REGISTRATION ACCEPT message

If both of the conditions are not met, then the AMF may discard the received Deregistration Request message, or may reject the NAS message i.e. send the Deregistration Reject message and include any (e.g. existing) 5GMM cause value e.g. cause value #9 (UE identity cannot be derived by the network). Alternatively, the network may initiate the authentication procedure or the identity procedure or the security mode control procedure (in any order).

In a second option, the UE and network negotiate a new capability in order to agree/understand that a Deregistration Request message can contain a NAS message container IE and hence process it.

As indicated earlier, there needs to be a mechanism by which a UE should know when to include a NAS message container IE in a Deregistration Request message. Similarly, there needs to be a mechanism by which the network would understand that a Deregistration Request message from a UE may contain a NAS message container IE and hence process it.

Although the current reason to include a NAS message container IE in the Deregistration Request message is for sending the unavailability information, the UE and the network should exchange general capability information in order to be able to handle the NAS message container IE in a Deregistration Request message. Note that this means that the UE can send other non-cleartext IEs in the future and hence can also include the NAS message container IE when the UE needs to send other non-cleartext IEs which may include the Unavailability period duration IE or any other non-cleartext IE that may be introduced in the future.

It is therefore set out that the UE should indicate if it can support sending non-cleartext IEs in the Deregistration Request message, where this may also mean that the UE can send the NAS message container IE in the Deregistration Request message. This new capability indication should be sent by the UE in the 5GMM capability IE of the Registration Request message.

A new bit position can be defined to do so. For example, a new bit NC-DR—“Non-cleartext IE in Deregistration Request” can be defined where, for example, the value ‘1’ may mean “Non-cleartext IE in Deregistration Request supported” and the value ‘0’ may mean “Non-cleartext IE in Deregistration Request is not supported”.

Similarly, a new bit position can be defined and used by the network to indicate if the network can support the processing of non-cleartext IEs in the Deregistration Request message.

Alternatively, the bit can be defined and used by the network to indicate if the network can support the processing of the NAS message container IE in a Deregistration Request message. For example, this indication may be referred to by using a new bit NC-DR—“Non-cleartext IE in Deregistration Request” can be defined where, for example, the value ‘1’ may mean “Non-cleartext IE in Deregistration Request supported” and the value ‘0’ may mean “Non-cleartext IE in Deregistration Request is not supported”. This new bit may be included in the 5GS network feature support IE that can be sent in the Registration Accept message.

Note that the names set out herein for the UE or network should be considered as an example only and not as a limitation. As such any other name may be used for the UE or the network.

Optionally the details herein for the Deregistration Request message are for the case that the UE sends a Deregistration Request message (i.e. UE initiated procedure).

In one alternative, if the UE supports sending non-cleartext IEs in a Deregistration Request message (e.g. as set out above where the UE may provide a generic indication for this), and optionally if the network has indicated support for handling of non-cleartext IE in a Deregistration Request message, then when the UE wants to send the Unavailability period duration IE, the UE would do so as have been set out earlier i.e. the UE will include the Unavailability period duration IE in the NAS message container IE and then cipher the value part of the NAS message container IE. The UE then includes the NAS message container IE in the Deregistration Request message that is sent by the UE.

Note: handling of non-cleartext IE in a NAS message may also mean that the entity can handle the NAS message container IE in the NAS message, and vice versa.

Note: all the details herein may apply to other initial NAS messages that may be defined in the future and are thus not restricted to the Deregistration Request message only.

All the details herein are applicable in any order or combination and as such one of the steps may be handled or performed in a different order from what is listed herein.

The details above describe that the NAS message container IE would only include the non-cleartext IEs e.g. such as the Unavailability period duration IE. In another alternative, when the UE needs to send any non-cleartext IE in a Deregistration Request message, optionally where this is sent from 5GMM-IDLE mode (or from idle mode), then the UE behaves as follows, where the non-cleartext IE may be the Unavailability period duration IE (or any other IE that may be required to be sent in this NAS message):

the UE includes the entire DEREGISTRATION REQUEST message (i.e. containing both cleartext IEs and non-cleartext IEs) in the NAS message container IE and the UE shall cipher the value part of the NAS message container IE. The UE shall then send a DEREGISTRATION REQUEST message containing the cleartext IEs and the NAS message container IE.

If the UE does not need to send non-cleartext IEs in a DEREGISTRATION REQUEST message, the UE sends the DEREGISTRATION REQUEST message without including the NAS message container IE.

Note that an example of a non-cleartext IE may be the Unavailability period duration IE or any other non-cleartext IE which may be defined to be included in any initial NAS message such as the Deregistration Request message.

When applying initial NAS message protection to the DEREGISTRATION REQUEST message, the length of the key stream is set to the length of the entire plain NAS message that is included in the NAS message container IE, i.e. the value part of the NAS message container IE, that is to be ciphered.

When the AMF receives an integrity protected initial NAS message which includes a NAS message container IE, the AMF shall decipher the value part of the NAS message container IE. If the received initial NAS message is a DEREGISTRATION REQUEST message, the AMF shall consider the NAS message that is obtained from the NAS message container IE (e.g. a Deregistration Request message) as the initial NAS message that triggered the procedure.

If, during an ongoing (UE-initiated) deregistration procedure, the AMF is initiating a SECURITY MODE COMMAND (i.e. after receiving the DEREGISTRATION REQUEST message, but before sending a response to that message) and:
a) the DEREGISTRATION REQUEST message (where optionally the message includes a NAS message container IE) does not successfully pass the integrity check at the AMF; or
b) the AMF cannot decipher the value part of the NAS message container IE in the REGISTRATION REQUEST message;
the AMF shall include the Additional 5G security information IE with the RINMR bit set to “Retransmission of the initial NAS message requested” in the SECURITY MODE COMMAND message requesting the UE to send the entire DEREGISTRATION REQUEST message in the SECURITY MODE COMPLETE message as described in 3GPP TS 33.501.

If a DEREGISTRATION REQUEST message fails the integrity check, the AMF shall proceed as follows: If it is a deregistration request due to switch off and the DEREGISTRATION REQUEST message contains a NAS message container IE, and the AMF can initiate an authentication procedure, the AMF should authenticate the subscriber before processing the deregistration request any further. The AMF may then proceed as described next.

If during an ongoing deregistration procedure, the UE receives a SECURITY MODE COMMAND message which includes the Additional 5G security information IE with the RINMR bit set to “Retransmission of the initial NAS message requested”, the UE shall include the entire unciphered DEREGISTRATION REQUEST message which the UE had previously included in the NAS message container IE of the initial NAS message (i.e. DEREGISTRATION REQUEST message), in the NAS message container IE of the SECURITY MODE COMPLETE message.

A particular embodiment of the disclosure concerns the behavior of the UE and the use of Uplink data status IE when it sends a Service Request/Control Plane Service Request message in response to a paging or a notification received via non-3GPP access (except when the request to establish user plane resources is for emergency services or high priority access).

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

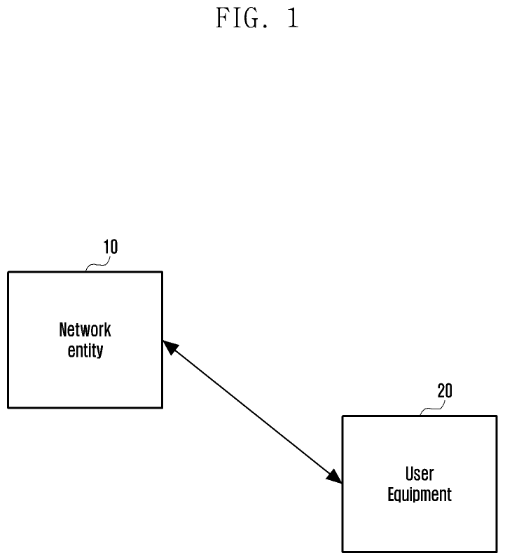

FIG. 1 shows a representation of a UE in communication with a network, according to an embodiment of the disclosure.

In an embodiment, a User Equipment 20, UE, communicatively coupled to a network entity 10.

A network entity 10 can be an entity of telecommunication network or 3rd generation partnership project (3GPP) network.

A network entity 10 of FIG. 1 may include a transceiver, a controller, and a storage unit. In the disclosure, the controller may be defined as a circuit, an application-specific integrated circuit, or at least one processor.

The transceiver may transmit or receive a signal to or from other network entities. The controller may control a signal flow between components of the network entity 10. The storage unit may store at least of information transmitted or received via the transceiver and information generated via the controller.

A user equipment (UE) 20 may include a transceiver, a controller, and a storage unit. In the disclosure, the controller may be defined as a circuit, an application-specific integrated circuit, or at least one processor.

The transceiver may transmit or receive a signal to or from other network entities. The controller may control a signal flow between components of the UE 20. The storage unit may store at least of information transmitted or received via the transceiver and information generated via the controller.

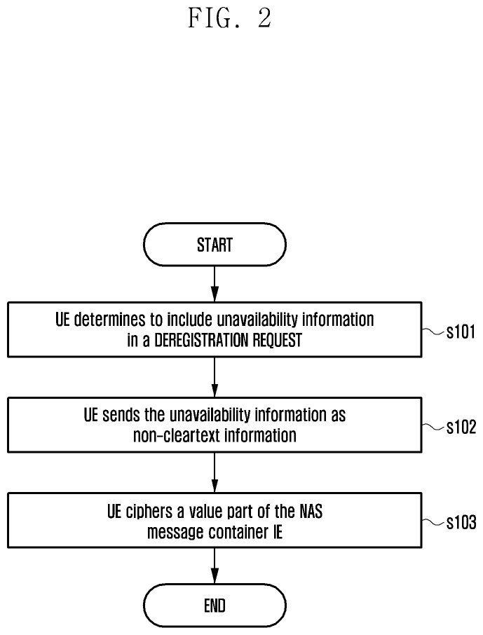

FIG. 2 shows a flowchart illustrating a method according to an embodiment.

At operation 8101, the UE determines to include unavailability information in a DEREGISTRATION REQUEST. At operation 8102, it sends the unavailability information as non-cleartext information. The Deregistration Request includes a NAS message container IE; a NAS message container IE contains an entire DEREGISTRATION REQUEST message which, in turn, includes the unavailability information; and at operation 8103 the UE ciphers a value part of the NAS message container IE.

The following sections of the description set out suggested changes to the standard specification TS 24.501. They are presented to assist in the understanding of embodiments of the disclosure and are not intended to be interpreted as the only way to achieve the aims of embodiments. The skilled person will understand that other formulations may be defined.

### 4.4.6 Protection of Initial NAS Signalling Messages

The 5GS supports protection of initial NAS messages as specified in 3GPP TS 33.501 [24]. The protection of initial NAS messages applies to the REGISTRATION REQUEST, DEREGISTRATION REQUEST, SERVICE REQUEST and CONTROL PLANE SERVICE REQUEST message, and is achieved as follows:
a) If the UE does not have a valid 5G NAS security context, the UE sends a REGISTRATION REQUEST message including cleartext IEs only. After activating a 5G NAS security context resulting from a security mode control procedure:
1) if the UE needs to send non-cleartext IEs, the UE shall include the entire REGISTRATION REQUEST message (i.e. containing both cleartext IEs and non-cleartext IEs) in the NAS message container IE and shall include the NAS message container IE in the SECURITY MODE COMPLETE message; or
2) if the UE does not need to send non-cleartext IEs, the UE shall include the entire REGISTRATION REQUEST message (i.e. containing cleartext IEs only) in the NAS message container IE and shall include the NAS message container IE in the SECURITY MODE COMPLETE message.
b) If the UE has a valid 5G NAS security context and:
1) the UE needs to send non-cleartext IEs in a REGISTRATION REQUEST, DEREGISTRATION REQUEST, or SERVICE REQUEST message, the UE includes the entire REGISTRATION REQUEST, DEREGISTRATION REQUEST or SERVICE REQUEST message (i.e. containing both cleartext IEs and non-cleartext IEs) in the NAS message container IE and shall cipher the value part of the NAS message container IE. The UE shall then send a REGISTRATION REQUEST, DEREGISTRATION REQUEST, or SERVICE REQUEST message containing the cleartext IEs and the NAS message container IE;
2) the UE needs to send non-cleartext IEs in a CONTROL PLANE SERVICE REQUEST message:
i) if CIoT small data container IE is the only non-cleartext IE to be sent, the UE shall cipher the value part of the CIoT small data container IE. The UE shall then send a CONTROL PLANE SERVICE REQUEST message containing the cleartext IEs and the CIoT small data container IE;
ii) otherwise, the UE includes non-cleartext IEs in the NAS message container IE and shall cipher the value part of the NAS message container IE. The UE shall then send a CONTROL PLANE SERVICE REQUEST message containing the cleartext IEs and the NAS message container IE;
3) the UE does not need to send non-cleartext IEs in a REGISTRATION REQUEST, DEREGISTRATION REQUEST, or SERVICE REQUEST message, the UE sends the REGISTRATION REQUEST, DEREGISTRATION REQUEST, or SERVICE REQUEST message without including the NAS message container IE; or
4) the UE does not need to send non-cleartext IEs in a CONTROL PLANE SERVICE REQUEST message, the UE sends the CONTROL PLANE SERVICE REQUEST message without including the NAS message container IE and the CIoT small data container IE.

When the initial NAS message is a REGISTRATION REQUEST message, the cleartext IEs are:
Extended protocol discriminator;
Security header type;
Spare half octet;
Registration request message identity;
5GS registration type;
ngKSI;
5GS mobile identity;
UE security capability;
Additional GUTI;
UE status;
EPS NAS message container;
NID; and
PLMN with disaster condition.

When the initial NAS message is a DEREGISTRATION REQUEST message, the cleartext IEs are:
Extended protocol discriminator;
Security header type;
Spare half octet;
De-registration request message identity;
De-registration type;
ngKSI; and
5GS mobile identity.

When the initial NAS message is a SERVICE REQUEST message, the cleartext IEs are:
Extended protocol discriminator;
Security header type;
Spare half octet;
ngKSI;
Service request message identity;
Service type; and
5G-S-TMSI.

When the initial NAS message is a CONTROL PLANE SERVICE REQUEST message, the cleartext IEs are:
Extended protocol discriminator;
Security header type;
Spare half octet;
ngKSI;
Control plane service request message identity; and
Control plane service type.

When the UE sends a REGISTRATION REQUEST, DEREGISTRATION REQUEST, SERVICE REQUEST, or CONTROL PLANE SERVICE REQUEST message that includes a NAS message container IE, the UE shall set the security header type of the initial NAS message to “integrity protected”.

When the AMF receives an integrity protected initial NAS message which includes a NAS message container IE, the AMF shall decipher the value part of the NAS message container IE. If the received initial NAS message is a REGISTRATION REQUEST, DEREGISTRATION REQUEST, or a SERVICE REQUEST message, the AMF shall consider the NAS message that is obtained from the NAS message container IE as the initial NAS message that triggered the procedure.

When the AMF receives a CONTROL PLANE SERVICE REQUEST message which includes a CIoT small data container IE, the AMF shall decipher the value part of the CIoT small data container IE and handle the message as specified in subclause 5.6.1.4.2.

If the UE:
a) has 5G-EA0 as a selected 5G NAS security algorithm; and
b) selects a PLMN other than Registered PLMN and EPLMN over one access;
the UE shall send an initial NAS message including cleartext IEs only via the access type associated with the newly selected PLMN as described in this subclause for the case when the UE does not have a valid 5G NAS security context.

If the UE:
a) has 5G-EA0 as a selected 5G NAS security algorithm; and
b) selects a PLMN other than Registered PLMN and EPLMN over one access, and the Registered PLMN or EPLMN is not registering or registered over other access;
the UE shall delete the 5G NAS security context.

NOTE: UE deletes the 5G NAS security context only if the UE is not in the connected mode.

### 5.4.2.2NAS Security Mode Control Initiation by the Network

The AMF initiates the NAS security mode control procedure by sending a SECURITY MODE COMMAND message to the UE and starting timer T3560 (see example in FIG. 5.4.2.2).

The AMF shall reset the downlink NAS COUNT counter and use it to integrity protect the initial SECURITY MODE COMMAND message if the security mode control procedure is initiated:
a) to take into use the security context created after a successful execution of the 5G authentication and key agreement (AKA) based primary authentication and key agreement procedure or the extensible authentication protocol (EAP) based primary authentication and key agreement procedure; or
b) upon receipt of REGISTRATION REQUEST message, if the AMF needs to create a mapped 5G NAS security context (i.e. the type of security context flag is set to “mapped security context” in the ngKSI IE included in the SECURITY MODE COMMAND message).

The AMF shall send the SECURITY MODE COMMAND message unciphered, but shall integrity protect the message with the 5G NAS integrity key based on K_{AMF} or mapped K′_{AMF} indicated by the ngKSI included in the message. The AMF shall set the security header type of the message to “integrity protected with new 5G NAS security context”.

The AMF shall create a locally generated K_{AMF} and send the SECURITY MODE COMMAND message including an ngKSI value in the ngKSI IE set to “000” and 5G-IA0 and 5G-EA0 as the selected NAS security algorithms only when the security mode control procedure is initiated:
a) during an initial registration procedure for emergency services if no valid 5G NAS security context is available;
b) during a registration procedure for mobility and periodic registration update for a UE that has an emergency PDU session if no valid 5G NAS security context is available;
c) during a service request procedure for a UE that has an emergency PDU session if no valid 5G NAS security context is available; or
d) after a failed primary authentication and key agreement procedure for a UE that has an emergency PDU session or is establishing an emergency PDU session, if continued usage of a valid 5G NAS security context is not possible.

When the AMF sends the SECURITY MODE COMMAND message including an ngKSI value in the ngKSI IE set to “000” and 5G-IA0 and 5G-EA0 as the selected NAS security algorithms, if:
a) the AMF supports N26 interface;
b) the UE set the S1 mode bit to “S1 mode supported” in the 5GMM capability IE of the REGISTRATION REQUEST message; and
c) the security mode control procedure is initiated during an initial registration procedure for emergency services, during a registration procedure for mobility and periodic registration update for a UE that has an emergency PDU session, or during a service request procedure for a UE that has an emergency PDU session,
the SECURITY MODE COMMAND message shall also include the Selected EPS NAS security algorithms IE. The selected EPS NAS security algorithms shall be set to EIA0 and EEA0.

The UE shall process a SECURITY MODE COMMAND message including an ngKSI value in the ngKSI IE set to “000” and 5G-IA0 and 5G-EA0 as the selected NAS security algorithms and, if accepted, create a locally generated K_{AMF} when the security mode control procedure is initiated:
a) during an initial registration procedure for emergency services;
b) during a registration procedure for mobility and periodic registration update for a UE that has an emergency PDU session;
c) during a service request procedure for a UE that has an emergency PDU session; or
d) after a primary authentication and key agreement procedure for a UE that has an emergency PDU session or is establishing an emergency PDU session.

NOTE 1: The process for creation of the locally generated K_{AMF} by the AMF and the UE is implementation dependent. The K_{AMF} is specified in 3GPP TS 33.501 [24].

Upon receipt of a REGISTRATION REQUEST message, if the AMF does not have the valid current 5G NAS security context indicated by the UE, the AMF shall either:
a) indicate the use of the new mapped 5G NAS security context to the UE by setting the type of security context flag in the ngKSI IE to “mapped security context” and the key set identifier (KSI) value related to the security context of the source system; or
b) set the ngKSI value to “000” in the ngKSI IE if the AMF sets 5G-IA0 and 5G-EA0 as the selected NAS security algorithms for a UE that has an emergency PDU session.

Upon receipt of a REGISTRATION REQUEST message, if the AMF has the valid current 5G NAS security context indicated by the UE, the AMF supports N26 interface and the UE set the S1 mode bit to “S1 mode supported” in the 5GMM capability IE of the REGISTRATION REQUEST message and the UE is not registered for disaster roaming services, the AMF shall check whether the selected EPS NAS security algorithms was successfully provided to the UE. If not, the AMF shall initiate the NAS security mode control procedure by sending a SECURITY MODE COMMAND message with the Selected EPS NAS security algorithms IE to the UE.

While having a current mapped 5G NAS security context with the UE, if the AMF needs to take the native 5G NAS security context into use, the AMF shall include the ngKSI that indicates the native 5G NAS security context in the SECURITY MODE COMMAND message.

The AMF shall include the replayed security capabilities of the UE (including the security capabilities with regard to NAS, radio resource control (RRC) and user plane (UP) ciphering as well as NAS and RRC integrity, and other possible target network security capabilities, i.e. evolved-universal terrestrial radio access network (E-UTRAN) if the UE included them in the message to network), the selected 5GS ciphering and integrity algorithms and the ngKSI.

If a UE is already registered over one access to a PLMN and the AMF decides to skip primary authentication and key agreement procedure when the UE attempts to register over the other access to the same PLMN, the AMF shall take into use the UE's current 5G NAS security context over the other access that the UE is registering. In this case, SECURITY MODE COMMAND message is not sent to the UE.

If the UE is registered to the same AMF and the same PLMN over both 3GPP access and non-3GPP access, and the UE is in 5GMM-CONNECTED mode over both the 3GPP and non-3GPP accesses, then at any time the primary authentication and key agreement procedure has successfully completed over:
a) the 3GPP access, the AMF includes the ngKSI in the SECURITY MODE COMMAND message over the 3GPP access. When the AMF sends the SECURITY MODE COMMAND message to UE over the non-3GPP access to take into use the new 5G NAS security context, the AMF shall include the same ngKSI in the SECURITY MODE COMMAND message to identify the new 5G NAS security context; or
b) the non-3GPP access, the AMF includes the ngKSI in the SECURITY MODE COMMAND message over the non-3GPP access. When the AMF sends the SECURITY MODE COMMAND message to UE over the 3GPP access to take into use the new 5G NAS security context, the AMF shall include the same ngKSI in the SECURITY MODE COMMAND message to identify the new 5G NAS security context.

The AMF may initiate a SECURITY MODE COMMAND in order to change the 5G security algorithms for a current 5G NAS security context already in use. The AMF re-derives the 5G NAS keys from K_{AMF} with the new 5G algorithm identities as input and provides the new 5GS algorithm identities within the SECURITY MODE COMMAND message. The AMF shall set the security header type of the message to “integrity protected with new 5G NAS security context”.

If, during an ongoing registration procedure, the AMF is initiating a SECURITY MODE COMMAND (i.e. after receiving the REGISTRATION REQUEST message, but before sending a response to that message) and:
a) the REGISTRATION REQUEST message does not successfully pass the integrity check at the AMF; or
b) the AMF cannot decipher the value part of the NAS message container IE in the REGISTRATION REQUEST message;
the AMF shall include the Additional 5G security information IE with the RINMR bit set to “Retransmission of the initial NAS message requested” in the SECURITY MODE COMMAND message requesting the UE to send the entire REGISTRATION REQUEST message in the SECURITY MODE COMPLETE message as described in 3GPP TS 33.501 [24].

If, during an ongoing deregistration procedure, the AMF is initiating a SECURITY MODE COMMAND (i.e. after receiving the DEREGISTRATION REQUEST message, but before sending a response to that message) and:
a) the DEREGISTRATION REQUEST message does not successfully pass the integrity check at the AMF; or
b) the AMF cannot decipher the value part of the NAS message container IE in the DEREGISTRATION REQUEST message;
the AMF shall include the Additional 5G security information IE with the RINMR bit set to “Retransmission of the initial NAS message requested” in the SECURITY MODE COMMAND message requesting the UE to send the entire DEREGISTRATION REQUEST message in the SECURITY MODE COMPLETE message as described in 3GPP TS 33.501 [24].

NOTE 2: The AMF uses the UE security capability which was provided by the UE.

If, during an ongoing service request procedure for a UE with an emergency PDU session, the AMF is initiating a SECURITY MODE COMMAND (i.e. after receiving the SERVICE REQUEST message or the CONTROL PLANE SERVICE REQUEST message, but before sending a response to that message) and the SERVICE REQUEST message or the CONTROL PLANE SERVICE REQUEST message does not successfully pass the integrity check at the AMF, the AMF shall include the Additional 5G security information IE with the RINMR bit set to “Retransmission of the initial NAS message requested” in the SECURITY MODE COMMAND message requesting the UE to send the entire:
a) SERVICE REQUEST message; or
b) CONTROL PLANE SERVICE REQUEST message excluding non-cleartext IEs, except the Uplink data status IE if needed (see subclause 5.4.2.3);
in the SECURITY MODE COMPLETE message as described in 3GPP TS 33.501 [24].

Additionally, the AMF may request the UE to include its IMEISV in the SECURITY MODE COMPLETE message.

If the AMF supports N26 interface and the UE set the S1 mode bit to “S1 mode supported” in the 5GMM capability IE of the REGISTRATION REQUEST message and the AMF needs to provide the selected EPS NAS security algorithms to the UE, the AMF shall select ciphering and integrity algorithms to be used in the EPS and indicate them to the UE via the Selected EPS NAS security algorithms IE in the SECURITY MODE COMMAND message.

NOTE 3: The AS and NAS security capabilities are the same, i.e. if the UE supports one algorithm for NAS, the same algorithm is also supported for AS.

If the AMF performs horizontal key derivation e.g. during the mobility and periodic registration update or when the UE is already registered in the PLMN with another access type as described in 3GPP TS 33.501 [24], the AMF shall include horizontal derivation parameter in the SECURITY MODE COMMAND message.

If the security mode control procedure is initiated after successful EAP based primary authentication and key agreement procedure and the security mode control procedure intends to bring into use the partial native 5G NAS security context created by the EAP based primary authentication and key agreement procedure, the AMF shall set the EAP message IE of the SECURITY MODE COMMAND message to an EAP-success message to be sent to the UE.

### 5.4.2.3NAS Security Mode Command Accepted by the UE

Upon receipt of the SECURITY MODE COMMAND message, the UE shall check whether the security mode command can be accepted or not. This is done by performing the integrity check of the message, and by checking that the received Replayed UE security capabilities IE has not been altered compared to the latest values that the UE sent to the network.

When the SECURITY MODE COMMAND message includes an EAP-success message the UE handles the EAP-success message and the ABBA as described in subclause 5.4.1.2.2.8, 5.4.1.2.3.1, 5.4.1.2.3A.1 and 5.4.1.2.3B.1.

If:
a) the UE is registered for emergency services, performing initial registration for emergency services, establishing an emergency PDU session or has an emergency PDU session established;
b) the wireless access gateway function (W-AGF) acts on behalf of the fixed network-residential gateway (FN-RG); or
c) the W-AGF acts on behalf of the N5GC device,
and the SECURITY MODE COMMAND message is received with ngKSI value “000” and 5G-IA0 and 5G-EA0 as selected 5G NAS security algorithms, the UE shall locally derive and take in use 5G NAS security context. The UE shall delete existing current 5G NAS security context.

The UE shall accept a SECURITY MODE COMMAND message indicating the “null integrity protection algorithm” 5G-IA0 as the selected 5G NAS integrity algorithm only if the message is received when
a) the UE is registered for emergency services, performing initial registration for emergency services, establishing an emergency PDU session or has an emergency PDU session established; or
b) the W-AGF acts on behalf of the FN-RG; or
c) the W-AGF acts on behalf of the N5GC device.

If the type of security context flag included in the SECURITY MODE COMMAND message is set to “native security context” and if the ngKSI matches a valid non-current native 5G NAS security context held in the UE while the UE has a mapped 5G NAS security context as the current 5G NAS security context, the UE shall take the non-current native 5G NAS security context into use which then becomes the current native 5G NAS security context and delete the mapped 5G NAS security context.

The UE shall ignore the Replayed S1 UE security capabilities IE if this IE is included in the SECURITY MODE COMMAND message.

If the SECURITY MODE COMMAND message can be accepted, the UE shall take the 5G NAS security context indicated in the message into use. The UE shall in addition reset the uplink NAS COUNT counter if:
a) the SECURITY MODE COMMAND message is received in order to take a 5G NAS security context into use created after a successful execution of the 5G AKA based primary authentication and key agreement procedure or the EAP based primary authentication and key agreement procedure; or
b) the SECURITY MODE COMMAND message received includes the type of security context flag set to “mapped security context” in the NAS key set identifier IE the ngKSI does not match the current 5G NAS security context, if it is a mapped 5G NAS security context.

If the SECURITY MODE COMMAND message can be accepted and a new 5G NAS security context is taken into use and SECURITY MODE COMMAND message does not indicate the “null integrity protection algorithm” 5G-IA0 as the selected NAS integrity algorithm, the UE shall:
if the SECURITY MODE COMMAND message has been successfully integrity checked using an estimated downlink NAS COUNT equal to 0, then the UE shall set the downlink NAS COUNT of this new 5G NAS security context to 0;
otherwise, the UE shall set the downlink NAS COUNT of this new 5G NAS security context to the downlink NAS COUNT that has been used for the successful integrity checking of the SECURITY MODE COMMAND message.

If the SECURITY MODE COMMAND message includes the horizontal derivation parameter indicating “K_{AMF} derivation is required”, the UE shall derive a new K′_{AMF}, as specified in 3GPP TS 33.501 [24] for K_{AMF} to K′_{AMF} derivation in mobility, and set both uplink and downlink NAS COUNTs to zero. When the new 5G NAS security context is taken into use for current access and the UE is registered with the same PLMN over the 3GPP access and the non-3GPP access:
a) the UE is in 5GMM-IDLE mode over the non-current access, the AMF and the UE shall activate the new 5G NAS security context over the non-current access as described in 3GPP TS 33.501 [24]. The AMF and the UE shall set the downlink NAS COUNT and uplink NAS COUNT to zero for the non-current access; or
b) the UE is in 5GMM-CONNECTED mode over the non-current access, the AMF shall send the SECURITY MODE COMMAND message over the non-current access to activate the new 5G NAS security context that was activated over the current access as described in 3GPP TS 33.501 [24]. The AMF shall include the same ngKSI in the SECURITY MODE COMMAND message to identify the new 5G NAS security context.

NOTE 1: If the UE was in 5GMM-CONNECTED mode over the non-current access when the new 5G NAS security context was taken into use for the current access and the UE enters 5GMM-IDLE mode over the non-current access before receiving a SECURITY MODE COMMAND message over the non-current access, the UE conforms to bullet a).

NOTE 2: If the UE was in 5GMM-CONNECTED mode over the non-current access when the new 5G NAS security context was taken into use and the N1 NAS signalling connection is lost over the non-current access before sending a SECURITY MODE COMMAND message over the non-current access, the AMF conforms to bullet a).

If the SECURITY MODE COMMAND message includes the horizontal derivation parameter indicating “K_{AMF} derivation is not required” or the Additional 5G security information IE is not included in the message, the UE is registered with the same PLMN over the 3GPP access and non-3GPP access, then after the completion of a security mode control procedure over the current access:
a) the UE is in 5GMM-IDLE mode over the non-current access, the AMF and the UE shall activate the new 5G NAS security context for the non-current access. If a primary authentication and key agreement procedure was completed before the security mode control procedure, the AMF and the UE shall set the downlink NAS COUNT and uplink NAS COUNT to zero for the non-current access, otherwise the downlink NAS COUNT and uplink NAS COUNT for the non-3GPP access are not changed; or
b) the UE is in 5GMM-CONNECTED mode over the non-current access, the AMF shall send the SECURITY MODE COMMAND message over the non-current access to activate the new 5G NAS security context that was activated over the current access as described in 3GPP TS 33.501 [24]. The AMF shall include the same ngKSI in the SECURITY MODE COMMAND message to identify the new 5G NAS security context.

NOTE 3: If the UE was in 5GMM-CONNECTED mode over the non-current access when the new 5G NAS security context was taken into use for the current access and the UE enters 5GMM-IDLE mode over the non-current access before receiving a SECURITY MODE COMMAND message over the non-current access, the UE conforms to bullet a).

NOTE 4: If the UE was in 5GMM-CONNECTED mode over the non-current access when the new 5G NAS security context was taken into use and the N1 NAS signalling connection is lost over the non-current access before sending a SECURITY MODE COMMAND message over the non-current access, the AMF conforms to bullet a).

If the SECURITY MODE COMMAND message can be accepted, the UE shall send a SECURITY MODE COMPLETE message integrity protected with the selected 5GS integrity algorithm and the 5G NAS integrity key based on the K_{AMF} or mapped K′_{AMF} if the type of security context flag is set to “mapped security context” indicated by the ngKSI. When the SECURITY MODE COMMAND message includes the type of security context flag set to “mapped security context” in the NAS key set identifier IE, then the UE shall check whether the SECURITY MODE COMMAND message indicates the ngKSI of the current 5GS security context, if it is a mapped 5G NAS security context, in order not to re-generate the K′_{AMF}.

Furthermore, if the SECURITY MODE COMMAND message can be accepted, the UE shall cipher the SECURITY MODE COMPLETE message with the selected 5GS ciphering algorithm and the 5GS NAS ciphering key based on the K_{AMF} or mapped K′_{AMF} indicated by the ngKSI. The UE shall set the security header type of the message to “integrity protected and ciphered with new 5G NAS security context”.

From this time onward the UE shall cipher and integrity protect all NAS signalling messages with the selected 5GS integrity and ciphering algorithms.

If the AMF indicated in the SECURITY MODE COMMAND message that the IMEISV is requested and:
a) if the UE:
1) supports at least one 3GPP access technology, the UE shall include its IMEISV in the IMEISV IE of the SECURITY MODE COMPLETE message; or
2) does not support any 3GPP access technology (i.e. satellite NG-RAN, NG-RAN, satellite E-UTRAN, E-UTRAN, UTRAN or GERAN) and supports NAS over untrusted or trusted non-3GPP access, the UE shall include its EUI-64 in the non-IMEISV PEI IE of the SECURITY MODE COMPLETE message; or
b) if the 5G-RG contains neither an IMEISV nor an IMEI or when the W-AGF acts on behalf of the FN-RG (or on behalf of the N5GC device), the 5G-RG or the W-AGF acting on behalf of the FN-RG (or on behalf of the N5GC device) shall include the MAC address and the MAC address usage restriction indication determined as specified in subclause 5.3.2 in the non-IMEISV PEI IE in the SECURITY MODE COMPLETE message.

If during an ongoing registration procedure, deregistration procedure, or service request procedure, the UE receives a SECURITY MODE COMMAND message which includes the Additional 5G security information IE with the RINMR bit set to “Retransmission of the initial NAS message requested”, the UE shall include the entire unciphered REGISTRATION REQUEST message, DEREGISTRATION REQUEST message, SERVICE REQUEST message or CONTROL PLANE SERVICE REQUEST message, which the UE had previously included in the NAS message container IE of the initial NAS message (i.e. REGISTRATION REQUEST message, DEREGISTRATION REQUEST MESSAGE, SERVICE REQUEST message or CONTROL PLANE SERVICE REQUEST message, respectively), in the NAS message container IE of the SECURITY MODE COMPLETE message. The retransmitted CONTROL PLANE SERVICE REQUEST message:
a) shall not include any non-cleartext IE, except the Uplink data status IE; and
b) may include the Uplink data status IE.

If, prior to receiving the SECURITY MODE COMMAND message, the UE without a valid 5G NAS security context had sent a REGISTRATION REQUEST message the UE shall include the entire REGISTRATION REQUEST message in the NAS message container IE of the SECURITY MODE COMPLETE message as described in subclause 4.4.6.

If the UE operating in the single-registration mode receives the Selected EPS NAS security algorithms IE, the UE shall use the IE according to 3GPP TS 33.501 [24].

For a UE operating in single-registration mode in a network supporting N26 interface after an inter-system change from S1 mode to N1 mode in 5GMM-CONNECTED mode, the UE shall set the value of the Selected EPS NAS security algorithms IE in the 5G NAS security context to the NAS security algorithms that were received from the source MME when the UE was in S1 mode.

### 5.4.2.4NAS Security Mode Control Completion by the Network

The AMF shall, upon receipt of the SECURITY MODE COMPLETE message, stop timer T3560. From this time onward the AMF shall integrity protect and encipher all signalling messages with the selected 5GS integrity and ciphering algorithms.

If the SECURITY MODE COMPLETE message contains a NAS message container IE with a REGISTRATION REQUEST message, the AMF shall complete the ongoing registration procedure by considering the REGISTRATION REQUEST message contained in the NAS message container IE as the message that triggered the procedure.

If the SECURITY MODE COMPLETE message contains a NAS message container IE with a DEREGISTRATION REQUEST message, the AMF shall complete the ongoing deregistration procedure by considering the DEREGISTRATION REQUEST message contained in the NAS message container IE as the message that triggered the procedure.

If the SECURITY MODE COMPLETE message contains a NAS message container IE with a REGISTRATION REQUEST message, the 5GMM capability IE included in the REGISTRATION REQUEST message indicates “S1 mode supported” and the AMF supports N26 interface, the AMF shall initiate another NAS security mode control procedure in order to provide the selected EPS NAS security algorithms to the UE as described in subclause 5.4.2.2. This second NAS security mode control procedure should be initiated as part of 5GMM common procedures of the ongoing registration procedure.

If the SECURITY MODE COMPLETE message contains a NAS message container IE with a SERVICE REQUEST message, the AMF shall complete the ongoing service request procedure by considering the SERVICE REQUEST message contained in the NAS message container IE as the message that triggered the procedure.

If the SECURITY MODE COMPLETE message contains a NAS message container IE with a CONTROL PLANE SERVICE REQUEST message, the AMF shall complete the ongoing service request procedure by considering the CONTROL PLANE SERVICE REQUEST message contained in the NAS message container IE as the message that triggered the procedure.

### 5.5.2.2.1 UE-Initiated De-Registration Procedure Initiation

The de-registration procedure is initiated by the UE by sending a DEREGISTRATION REQUEST message (see example in FIG. 5.5.2.2.1). The De-registration type IE included in the message indicates whether the de-registration procedure is due to a “switch off” or not. The access type included in the message indicates whether the de-registration procedure is:
a) for 5GS services over 3GPP access when the UE is registered over 3GPP access;
b) for 5GS services over non-3GPP access when the UE is registered over non-3GPP access; or
c) for 3GPP access, non-3GPP access or both when the UE is registered in the same PLMN over both accesses.

If the UE has a valid 5G-GUTI, the UE shall populate the 5GS mobile identity IE with the valid 5G-GUTI. If the UE does not have a valid 5G-GUTI, the UE shall populate the 5GS mobile identity IE with its SUCI as follows:
a) if timer T3519 is not running, generate a fresh SUCI as specified in 3GPP TS 33.501 [24], send a DEREGISTRATION REQUEST message with the SUCI, start timer T3519 and store the value of the SUCI sent in the DEREGISTRATION REQUEST message; and
b) if timer T3519 is running, send a DEREGISTRATION REQUEST message with the stored SUCI.

If the UE does not have a valid 5G-GUTI and it does not have a valid SUCI, then the UE shall populate the 5GS mobile identity IE with its PEI.

If the de-registration request is not due to switch off and the UE is in the state 5GMM-REGISTERED or 5GMM-REGISTERED-INITIATED, timer T3521 shall be started in the UE after the DEREGISTRATION REQUEST message has been sent. The UE shall enter the state 5GMM-DEREGISTERED-INITIATED.

If the UE is to be switched off, the UE shall try for a period of 5 seconds to send the DEREGISTRATION REQUEST message. During this period, the UE may be switched off as soon as the DEREGISTRATION REQUEST message has been sent.

If the network indicated support for the unavailability period in the last registration procedure; and an event is triggered in the UE that would make the UE unavailable for a certain period, and the UE is unable to store its 5GMM and 5GSM contexts, the UE shall include the Unavailability period duration IE, set the De-registration type to “Normal de-registration”, in the DEREGISTRATION REQUEST message. The UE shall start the timer T3521 and enter the state 5GMM-DEREGISTERED-INITIATED.

If the UE is sending the DEREGISTRATION REQUEST message from 5GMM-IDLE mode and the UE needs to send non-cleartext IEs, the UE shall send the DEREGISTRATION REQUEST message including the NAS message container IE as described in subclause 4.4.6.

### 8.2.12.1 Message Definition

The DEREGISTRATION REQUEST message is sent by the UE to the AMF. See table 8.2.12.1.1.
Message type: DEREGISTRATION REQUEST
Significance: dual
Direction: UE to network

| | Information | Type/ | | | |
|---|---|---|---|---|---|
| IEI | Element | Reference | Presence | Format | Length |
| | Extended | Extended | M | V | 1 |
| | protocol | protocol | | | |
| | discriminator | discriminator 9.2 | | | |
| | Security header | Security header | M | V | 1/2 |
| | type | type 9.3 | | | |
| | Spare half octet | Spare half octet | M | V | 1/2 |
| | | 9.5 | | | |
| | De-registration | Message type | M | V | 1 |
| | request message | 9.7 | | | |
| | identity | | | | |
| | De-registration | De-registration | M | V | 1/2 |
| | type | type 9.11.3.20 | | | |
| | ngKSI | NAS key set | M | V | 1/2 |
| | | identifier | | | |
| | | 9.11.3.32 | | | |
| | 5GS mobile | 5GS mobile | M | LV-E | 6-n |
| | identity | identity | | | |
| | | 9.11.3.4 | | | |
| 3C | Unavailability | GPRS timer 3 | O | TLV | 3 |
| | period | 9.11.2.5 | | | |
| | duration | | | | |
| 71 | NAS message | NAS message | O | TLV-E | 4-n |
| | container | container | | | |
| | | 9.11.3.33 | | | |

### 8.2.12.X NAS Message Container

This IE shall be included if the UE is sending a DEREGISTRATION REQUEST message as an initial NAS message and the UE needs to send non-cleartext IEs.

Although a few preferred embodiments of the disclosure have been shown and described, it will be appreciated by those skilled in the art that various changes and modifications might be made without departing from the scope of the disclosure, as defined in the appended claims.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

The disclosure is not restricted to the details of the foregoing embodiment(s). The disclosure extends to any novel one, or any novel combination, of the features disclosed in this specification (including any accompanying claims, abstract and drawings), or to any novel one, or any novel combination, of the steps of any method or process so disclosed.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Furthermore, the above respective embodiments may be employed in combination, as necessary. For example, at least a part of each of the embodiments of the disclosure may be combined with each other and operated by a base station, a terminal, or a specific network entity.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication network, the method comprising:
determining to include unavailability information in a deregistration request message; and
transmitting, to a network entity, the deregistration request message, wherein the unavailability information is included in the deregistration request message as non-cleartext information,
wherein the deregistration request message includes a non-access stratum (NAS) message container information element (IE),
wherein the unavailability information is included in the NAS message container IE, and
wherein at least a part of the NAS message container IE is ciphered by the UE.

2. The method of claim 1, wherein the NAS message container IE is an unavailability period duration IE.

3. The method of claim 1, wherein the unavailability information indicates unavailability period duration of the UE.

4. The method of claim 1, wherein the UE is in a 5G mobility management (5GMM)-IDLE mode.

5. The method of claim 1, further comprising:
starting a timer T3521 after transmitting the deregistration request message.

6. The method of claim 1, wherein de-registration type information in the deregistration request message is set to normal de-registration.

7. A user equipment (UE) in a wireless communication system, the UE comprising:
a transceiver;
memory storing one or more computer programs; and
one or more processors communicatively coupled to the transceiver and the memory,
wherein the one or more computer programs include computer-executable instructions that, when executed by the one or more processors, cause the UE to:
determine to include unavailability information in a deregistration request message, and
transmit, to a network entity, the deregistration request message, wherein the unavailability information is included in the deregistration request message as non-cleartext information,
wherein the deregistration request message includes a non-access stratum (NAS) message container information element (IE),
wherein the unavailability information is included in the NAS message container IE, and
wherein at least a part of the NAS message container IE is ciphered by the UE.

8. The UE of claim 7, wherein the NAS message container IE is an unavailability period duration IE.

9. The UE of claim 7, wherein the unavailability information indicates unavailability period duration of the UE.

10. The UE of claim 7, wherein the UE is in a 5G mobility management (5GMM)-IDLE mode.

11. The UE of claim 7, wherein the one or more computer programs further include computer-executable instructions that, when executed by the one or more processors, cause the UE to:
start a timer T3521 after transmitting the deregistration request message.

12. The UE of claim 7, wherein de-registration type information in the deregistration request message is set to normal de-registration.
